(19) United States
(12) Patent Application Publication
(10) Pub. No.: US 2011/0279871 A1
(43) Pub. Date: Nov. 17, 2011

(54) IMAGE FORMING APPARATUS AND METHOD OF CONTROLLING THE APPARATUS, AND PROGRAM

(75) Inventor: Tomoaki OSADA, Yokohama-shi (JP)

(73) Assignee: CANON KABUSHIKI KAISHA, Tokyo (JP)

(21) Appl. No.: 13/104,320

(22) Filed: May 10, 2011

(30) Foreign Application Priority Data
May 12, 2010 (JP) 2010-110596

(51) Int. Cl. G06K 15/00

(52) U.S. Cl. 358/1.16

(57) ABSTRACT

It is determined whether or not there is an available area to store composite image data, in addition to inputted image data, in a storage device for storage of image data. When it is determined that there is an available area, the composite image data obtained by combining is stored in addition to the input image data. When it is determined that there is no available area, the input image data is stored into the storage device. Upon image formation, when composite image data is stored in the storage device, an image is formed in accordance with the composite image data. When it is determined that composite image data is not stored, an image is formed by generating composite image data based on image data read from the storage device.

### BACKGROUND OF THE INVENTION

1. Field of the Invention

The present invention relates to an image forming apparatus, a method of controlling the image forming apparatus and a program therefore.

2. Description of the Related Art

An image forming apparatus represented by a digital multi function peripheral having functions of a copier, a facsimile machine, a printer and the like, generally has a storage device (memory) and can store image and various data into the storage device. Further, the apparatus can perform modification and editing on image data in addition to storage of image data. Further, the storage device is utilized for various purposes e.g. storage of image data of plural pages of original document into the storage device for later electronic sorting. As this storage device, a hard disk (HDD), a non-volatile semiconductor memory and the like are used. Although the access speed of the hard disk is slow and the reliability is rather low, it is capable of storing a large amount of data. On the other hand, the semiconductor memory is high-speed accessible and has high reliability. As long as the capacity is small, the semiconductor memory can be introduced at a lower cost than that of the hard disk. From this viewpoint, introduction of the semiconductor memory as a storage device of an image forming apparatus is becoming increasingly popularized.

In addition to this situation, in accordance with recent rapid progress of performance of image forming apparatuses, printing with image data composition processing such as copy-forgery-inhibited pattern printing, digital watermark printing, and printing of number of copies, for the purpose of improvement in security, is possible. For example, pattern printing is a technique of overlaying an image called a pattern on the background of a content (image). The copy-forgery-inhibited pattern image merely looks like a pattern in an original text (printed matter outputted from an image forming apparatus) but a predetermined character or the like appears when the pattern is duplicated. This has a diversion effect for counterfeit prevention on a person who duplicated the image.

However, the image composition processing is a very complicated processing and requires much processing time. For this reason, the printing speed is seriously lowered in comparison with general printing. Especially in the case of a low-price image forming apparatus, since specialized hardware for image composition cannot be incorporated in terms of cost, it is necessary to perform image composition processing by software processing. For this reason, upon printing with image composition, the printing speed is more seriously lowered. Accordingly, when image composition processing is required upon print setting for plural copies, previously-composition processed image data is stored in a storage device, then upon printing, the stored composite image data is read and print-outputted, thereby the reduction of printing speed is prevented.

When image composition is performed, as the amount of image data is increased, in a case where composite image data after composition is stored into the storage device, in an apparatus having a small capacity storage device such as the above-described semiconductor memory, there is a probability that the amount of image data exceeds the capacity of the storage device. Further, when the amount of image data exceeds the capacity of the storage device, the job cannot be continued. Accordingly, there is a problem in that it is necessary to perform image data composition processing upon printing instead of previously storing composite image data into the storage device.

To solve this problem, Japanese Patent Laid-Open No. 11-126249 proposes a method for reducing the size of image data by performing thinning processing on image data when there is a high probability that the amount of image data exceeds the capacity of a storage device. This method has a problem in that it is not appropriate to composition of fine pattern image and electronic watermark since the image quality is degraded by the thinning processing.

### SUMMARY OF THE INVENTION

An aspect of the present invention is to eliminate the above-mentioned problems with conventional technology.

According to another aspect of the present invention, it is provided a technique of determining whether or not composite image data is to be stored in accordance with an available area of a storage device for storing image data, and when composite image data is stored, forming an image in accordance with the composite image data, while when composite image data is not stored, performing image data composition upon image formation.

According to an aspect of the present invention, there is provided an image forming apparatus, comprising: an input unit to input image data; a composite image data generation unit to generate composite image data by combining first image data and second image data; a determination unit to determine whether or not there is an available area to store the composite image data, in addition to the image data inputted by the input unit, in a storage unit to store image data; a control unit to perform control to, when the determination unit determines that there is an available area, store the composite image data combined by the composite image data generation unit in addition to the image data inputted by the input unit into the storage unit, while when the determination unit determines that there is no available area, store the image data inputted by the input unit into the storage unit; and an image forming processing unit to, when the composite image data is stored in the storage unit upon image formation, form an image in accordance with the composite image data, while when the composite image data is not stored in the storage unit, form an image in accordance with the composite image data generated by the composite image data generation unit based on the image data read from the storage unit.

Further features and aspects of the present invention will become apparent from the following description of exemplary embodiments, with reference to the attached drawings.

### BRIEF DESCRIPTION OF THE DRAWINGS

The accompanying drawings, which are incorporated in and constitute a part of the specification, illustrate embodiments of the invention and, together with the description, serve to explain the principles of the invention.

FIG. 1 depicts an overview of a multi function peripheral according to an embodiment of the present invention;

FIG. 2 is a block diagram showing a hardware configuration of the multi function peripheral according to the embodiment;

FIG. 3 depicts an explanatory view of printing while reading compressed image data, decompressing and compositing the image data;

FIG. 4 depicts an explanatory view of reading and print-outputting composite and stored image data;

FIG. 5 is a flowchart describing an example of scan processing in FIG. 3 or FIG. 4;

FIG. 6 is a flowchart describing composition and print processing in FIG. 3;

FIG. 7 is a flowchart describing the composition processing in FIG. 4;

FIG. 8 is a flowchart describing the print processing in FIG. 4;

FIG. 9 is a flowchart describing switching between the processing in FIG. 3 and that in FIG. 4;

FIG. 10 is a flowchart describing the print processing when compressed image data before composition and compressed image data after composition exist in a non-volatile storage device as one job; and

FIG. 11 is a flowchart describing processing in a case where an available area of the non-volatile storage device is increased during a job in accordance with completion of another job or the like.

### DESCRIPTION OF THE EMBODIMENTS

Hereinbelow, an embodiment of the present invention will now be described hereinafter in detail, with reference to the accompanying drawings. It is to be understood that the following embodiment is not intended to limit the claims of the present invention, and that not all of the combinations of the aspects that are described according to the following embodiment are necessarily required with respect to the means to solve the problems according to the present invention. Note that in the following description, a multi function peripheral will be given as an example of an image forming apparatus according to the present invention. However, the image forming apparatus according to the present invention is also applicable to a printer as a single device.

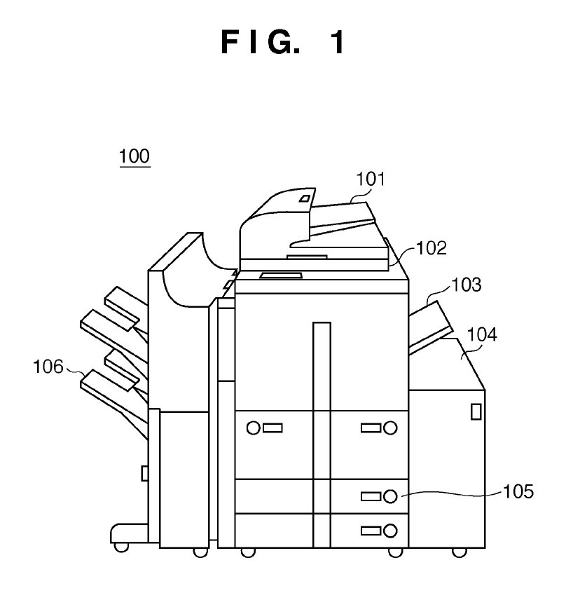

FIG. 1 depicts an overview of a multi function peripheral 100 according to an embodiment of the present invention.

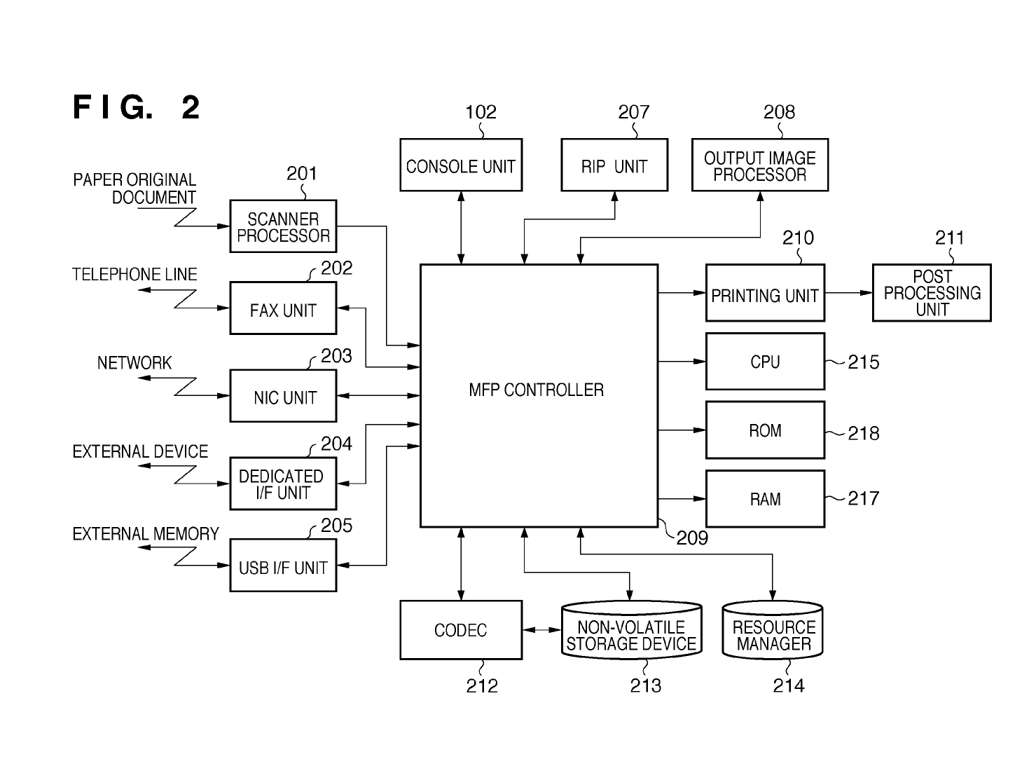

In FIG. 1, reference numeral 100 denotes an entire multi function peripheral. An auto document feeder (ADF) 101 feeds plural pages of an original document placed on a tray one by one onto a platen glass of a scanner processor 201 (FIG. 2) upon reading of the original document. A console unit 102 has a touch panel, keys and the like for various settings and control by a user, and has a display unit for checking device status or the like by the user. A manual feed unit 103 is used for manual setting of print sheets by the user. A side paper deck 104 holds a large number of print sheets and supplies the sheets to a printing unit 210 (FIG. 2). A cassette feeder 105 holds print sheets in various sizes on respective stages. A finisher 106 is capable of various finishing processings such as staple processing, punch processing and bookbinding processing.

FIG. 2 is a block diagram showing a hardware configuration of the multi function peripheral (MFP) 100 according to the embodiment.

The MFP 100 has a non-volatile storage device 213 such as a hard disk or a semiconductor memory capable of storing plural job data, a CPU 215, a RAM (main storage device) 217, and a ROM 218. The CPU 215 loads the programs stored into the non-volatile storage device 213 to the RAM 217 and executes the program, in accordance with a boot program in the ROM 218, to realize various functions. The MFP 100 has plural functions such as a copy function of printing data outputted from the scanner processor 201 with the printing unit 210 and a print function of rendering print data received from an external device via a network and print-outputting the data with the printing unit 210.

The scanner processor 201 reads an image of an original document on the platen glass, generates image data, performs image processing on the image data and outputs the processed image data. A FAX unit 202 performs image data transmission/reception utilizing a telephone line represented by facsimile. An NIC (Network Interface Card) unit 203 sends and receives image data and device information utilizing the network. A dedicated interface unit 204 performs information exchange of image data or the like with the external device. Further, a USB interface (USB I/F) unit 205 transmits/receives image data or the like to/from a USB device such as a USB memory.

An MFP controller 209 performs a function of traffic control such as processing data and commands inputted from the user using the console unit 102, temporary storage of image data in correspondence with purpose of the MFP 100, determination of image data transmission passage and the like. The non-volatile storage device 213 has a memory such as a hard disk capable of storing image data and various data. The MFP controller 209 can store e.g. image data inputted from the scanner processor 201 and image data from the external device such as a computer inputted via the NIC unit 203. Further, the MFP controller 209 arbitrarily reads image data stored in the non-volatile storage device 213, transfers the image data to the printing unit 210 to print-output the image data. Further, the MFP controller 209 performs control in accordance with an instruction from an operator using the console unit 102 so as to transfer image data read from the non-volatile storage device 213 to the external device such as the computer and another image forming apparatus. Upon storage of image data into the non-volatile storage device 213, the MFP controller 209 compresses the image data with a CODEC 212 and stores the compressed image data in accordance with necessity. On the other hand, upon reading of compressed and stored image data, the MFP controller 209 decompresses the image data to initial image data with the CODEC 212. Further, it is generally known that when data is passed via the network, compressed data format such as JPEG, JBIG or ZIP is used. When data has been inputted into the MFP 100, the data is decompressed with the CODEC 212. A resource manager 214 holds various commonly-handled parameter tables such as a font table, a color profile table and a gamma table. The contents of the tables can be called in accordance with necessity. Further, new parameter tables can be stored, modified and updated.

Next, when PDL data is inputted, the MFP controller 209 performs RIP (raster image processing) with a RIP unit 207. An output image processor 208 performs image processing for printing on an image to be printed in accordance with necessity. Further, intermediate data and print ready data of the image data (bitmap data for printing and compressed data from the bitmap data), generated in the above-described image processing, can be stored into the non-volatile storage device 213 in accordance with necessity. A sheet used in printing with the printing unit 210 is sent to a post processing unit 211, and finishing processing such as sheet sorting processing, staple processing, punch processing or bookbinding processing is performed there.

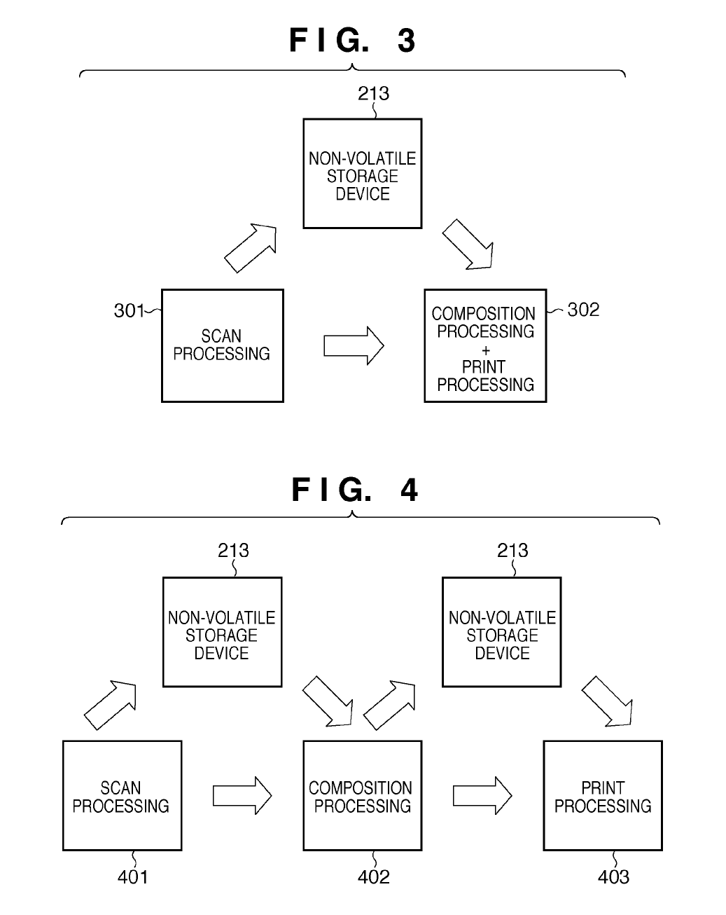

FIG. 3 depicts an explanatory view of an example where image data, obtained by scanning with the scanner processor 201, is compressed and stored into the non-volatile storage device 213, then upon (composition processing+print processing) 302, printing is performed while the compressed data is read, decompressed and combined. In this example, upon (composition processing+print processing) 302, composite image generation processing of combining the image data obtained by scan processing 301 with other image data is performed.

FIG. 4 depicts an explanatory view of an example where a composite image is generated from image data obtained by scanning with the scanner processor 201, then the generated image data is stored, and upon printing (upon image formation), the combined and stored composite image data is read and print-outputted.

Note that in this example, the non-volatile storage device 213 has an available area for storage of composite image data. The image data obtained by scan processing 401 is used in composition processing 402, and the composite image data is stored into the non-volatile storage device 213. Then, at print processing 403, the composite image data is read from the non-volatile storage device 213 and print-outputted.

Note that in the present embodiment, image data read with the scanner is inputted, however, the present invention is not limited to this type of image data. For example, image data inputted via the network or inputted from another device such as a connected storage medium may be used.

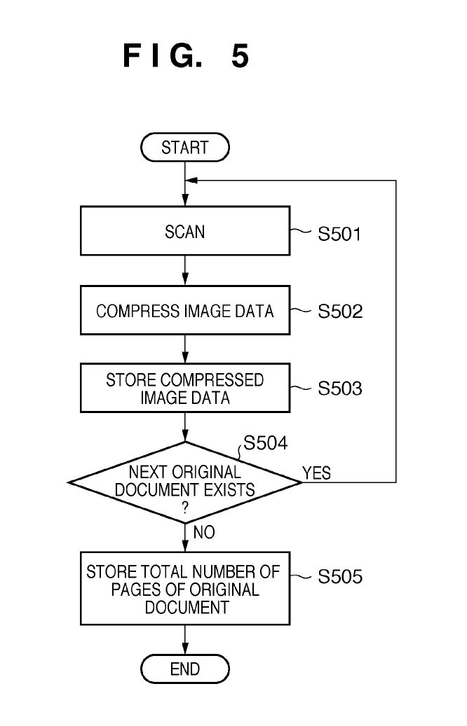

FIG. 5 is a flowchart describing an example of the scan processing 301 in FIG. 3 or FIG. 4. This processing is performed by execution of a program loaded to the RAM 217 with the CPU 215.

First, in step S501, a paper original document is scanned with the scanner processor 201, then image data is outputted, and the image data is stored into the RAM 217. Next, in step S502, the image data stored in the RAM 217 is read and compressed with the CODEC 212. Next, in step S503, the compressed data is stored into the non-volatile storage device 213. The flow of scanning processing for one page of original document is as above. When plural pages of the original document are placed on the ADF 101 of the scanner processor 201, it is determined in step S504 that the next original document exists, and the processing from step S501 is repeatedly performed. Then, once reading of all the original document has been completed, the process proceeds to step S505, in which the total number of pages of the read original document is stored into the non-volatile storage device 213 or the RAM 217. With this series of processing, all the images of the original documents as a processing subject is converted into electrical image data, compressed, and stored into the non-volatile storage device 213. The outline of the scan processing shown with numeral 301 in FIG. 3 and numeral 401 in FIG. 4 is as above.

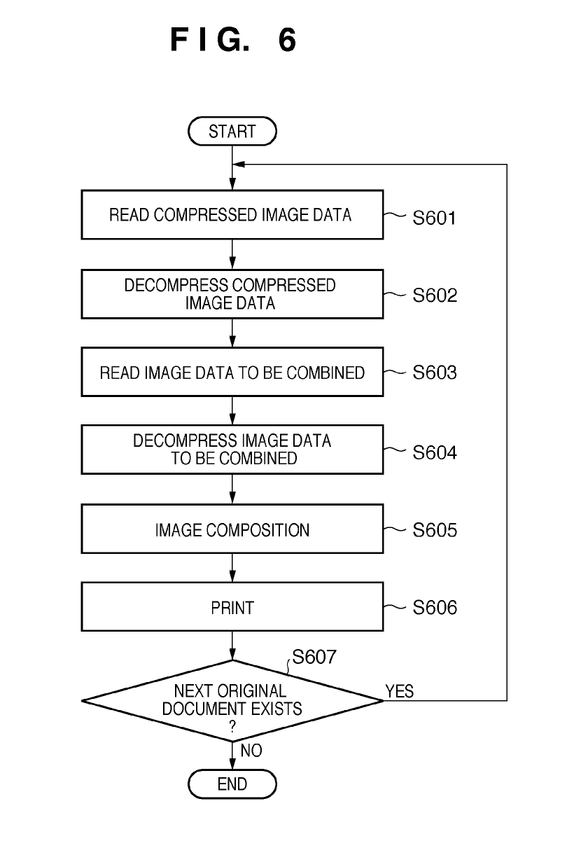

FIG. 6 is a flowchart describing composition and print processing 302 in FIG. 3. This processing is performed by execution of a program loaded to the RAM 217 with the CPU 215.

First, in step S601, image data, generated by the scan processing 301, compressed and stored in the non-volatile storage device 213, is read. The read compressed image data is decompressed with the CODEC 212 and stored into the RAM 217 in step S602. Next, in step S603, compressed image data to be combined stored in the non-volatile storage device 213 is read. In this example, the image data to be combined is previously stored in the non-volatile storage device 213. Further, the image data to be combined may be obtained by any one of other various methods such as generation of image data to be combined with the CPU 215 by execution of a program, or acquisition of image data to be combined by scan processing. Next, in step S604, the read compressed image data to be combined is decoded with the CODEC 212 and is stored into the RAM 217. Note that when the image data to be combined is obtained by the scan processing and is not compressed, the decompression processing of image data to be combined in step S604 is unnecessary. Then in step S605, composition processing is performed between the image data obtained by the scan processing (first image data) and the image data to be combined (second image data). The obtained composite image data is stored into the RAM 217. In this example, the composition processing is performed with the software processing by the CPU 215, however, the composition processing may be performed with unknown hardware processing. Next, the process proceeds to step S606, in which the composite image data stored in the RAM 217 is read, outputted to the printing unit 210 and print-outputted. Then in step S607, it is determined whether or not the next image data of the original document exists. When it is determined that the next image data of original document exists, the process proceeds to step S601 to repeat the above-described processing.

Note that generally, as the memory capacity of the RAM 217 incorporated in the image forming apparatus 100 is small, when the print processing has been completed, the print-outputted composite image data stored in the RAM 217 is deleted.

The processing in FIG. 3 is as described above. Since the composite image data is not stored into the non-volatile storage device 213, this method is advantageous when the memory capacity of the incorporated non-volatile storage device 213 is small. Further, the method is advantageous when the number of copies is one. However, as it is necessary to perform image data composition processing upon each printing, the printing speed is seriously lowered.

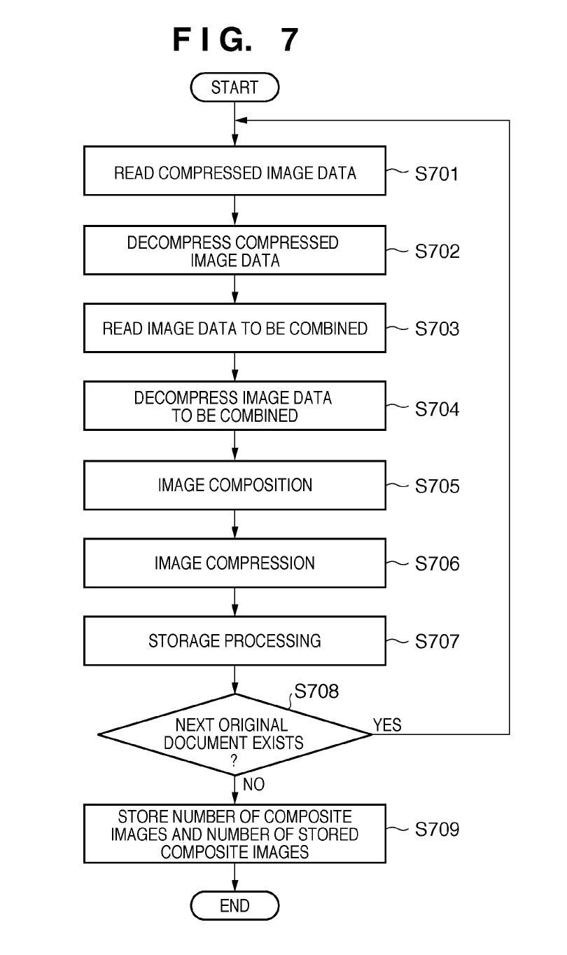

FIG. 7 is a flowchart describing the composition processing 402 in FIG. 4. This processing is performed by execution of a program loaded to the RAM 217 with the CPU 215.

In step S701, the compressed image data stored in the non-volatile storage device 213 in the scan processing 401 in FIG. 4 is read. Next, in step S702, the read compressed image data is decompressed with the CODEC 212 and stored into the RAM 217. Next, in step S703, the compressed image data to be combined stored in the non-volatile storage device 213 is read. In this example, the image data to be combined is previously stored in the non-volatile storage device 213. Further, the image data to be combined may be generated with the CPU 215 by execution of a program, or acquired by reading with the scanner processor 201. Then in step S704, the read compressed image data to be combined is decompressed with the CODEC 212 and stored into the RAM 217. Note that when the image data to be combined is obtained by e.g. scanning and the image data is not compressed, the decompression processing of the image data to be combined in step S704 is unnecessary. Next, the process proceeds to step S705, in which the image data stored in step S702 (first image data) and the image data to be combined stored in step S704 (second image data) are combined. The combined composite image data is stored into the RAM 217. In this example, the composition processing is performed with the software processing by the CPU 215, however, the composition processing may be performed with unknown hardware processing. Next, in step S706, the composite image data stored in the RAM 217 is compressed with the CODEC 212, and stored into the non-volatile storage device 213 in step S707. Next, in step S708, it is determined whether or not the next image data of original document exists. When it is determined that the next image data of the original document exists, the process proceeds to step S701 to repeat the above-described processing. Then, when the composite image data resulted from combining all the image data of the original document, stored in the scan processing 401, has been stored into the non-volatile storage device 213, the process proceeds to step S709. In step S709, the number of generated composite image data and the number of compressed composite image data stored in the non-volatile storage device 213 are stored into the non-volatile storage device 213 or the RAM 217, and the process ends.

With this processing, the composite image data, obtained by combining the image data obtained with the scanner processor 201 and the image data to be combined, is compressed and stored in the non-volatile storage device 213.

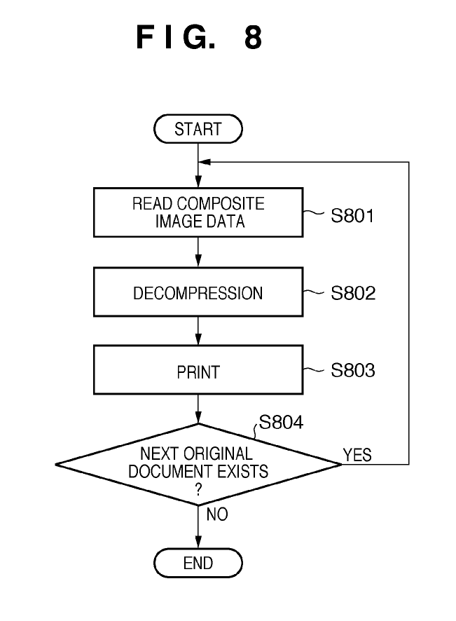

FIG. 8 is a flowchart describing the print processing 403 in FIG. 4. This processing is performed by execution of a program loaded to the RAM 217 with the CPU 215.

First, in step S801, the compressed composite image data stored in the non-volatile storage device 213 is read. This compressed image data is stored in step S707 in FIG. 7. The read compressed composite image data is decompressed with the CODEC 212 and stored into the RAM 217 in step S802. Next, in step S803, the composite image data stored in the RAM 217 is outputted to the printing unit 210 and print-outputted. Generally, as the capacity of the RAM 217 incorporated in the image forming apparatus 100 is small, after the completion of print processing, the print-outputted image data in the RAM 217 is deleted. Next, in step S804, it is determined whether or not the next composite image data to be print-outputted (next composite image data of original document) exists. When it is determined that the next composite image data of the next original document exists, the process proceeds to step S801 to repeat the above-described processing.

The print processing 403 in FIG. 4 is as described above. Since the composite image data after composition is stored in the non-volatile storage device 213, the method shown in FIG. 4 is advantageous when composite image data is print-outputted plural times (plural copies). However, when the storage capacity of the non-volatile storage device 213 incorporated in the image forming apparatus 100 is small, there is a probability that the composite image data cannot be stored.

Generally, when image data is combined, the amount of composite image data is larger than that of initial image data. Accordingly, regarding the image data before composition, all the pages of the data can be stored in the non-volatile storage device 213, however, when the composite image data after the composition is stored, there is a probability that the amount of data exceeds the memory capacity of the non-volatile storage device 213, and all the pages of the composite image data cannot be stored.

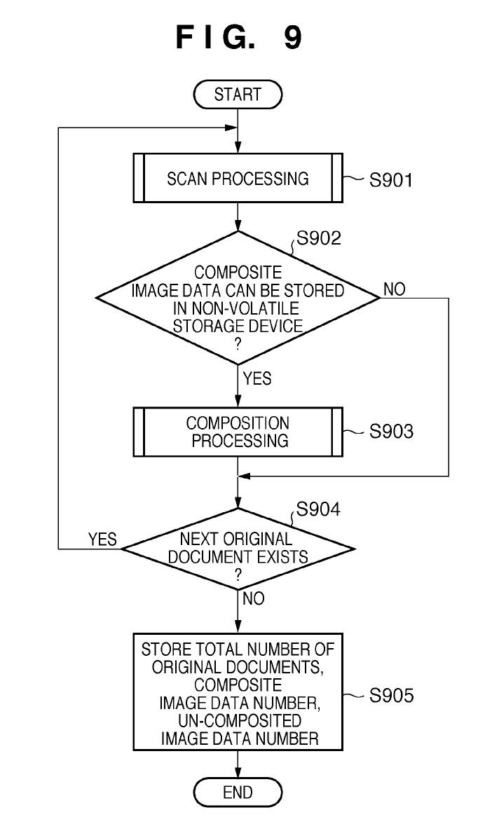

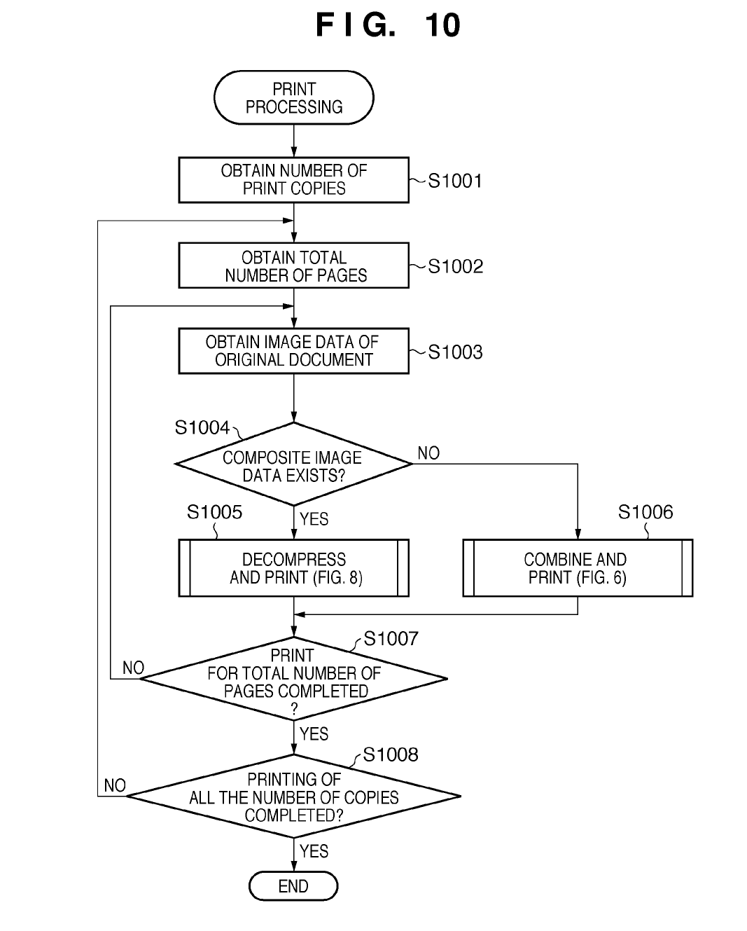

Next, a technique of improving the print processing speed by storing composite image data after composition into the non-volatile storage device 213 and preventing interruption of print processing due to data overflow in the non-volatile storage device 213, will be described with reference to FIGS. 9 to 11.

FIG. 9 is a flowchart describing switching between the processing in FIG. 3 and that in FIG. 4. This processing is performed by execution of a program loaded into the RAM 217 with the CPU 215.

First, in step S901, the image data, obtained with the scanner processor 201 by the scan processing of one page of the original document in the flowchart of FIG. 5, is compressed and stored into the non-volatile storage device 213. Further, in step S901, the number of pages of the scanned original document is counted. Next, in step S902, it is determined whether or not there is an available area for storing composite image data in the non-volatile storage device 213. When it is determined that there is an available area, the process proceeds to composition processing in step S903. As the processing in step S903 is the same as the image composition processing for one page of the original document in the flowchart of FIG. 7, the explanation of the processing will be omitted. With this processing in step S903, the composite image data after composition, in compressed status, is stored into the non-volatile storage device 213, and the process proceeds to step S904. In step S903, an image number of the stored composite image data is stored. On the other hand, when it is determined in step S902 that there is no available area for storing composite image data in the non-volatile storage device 213, the image number of the composite image data is stored (image number of non-stored composite image data) and the process proceeds to step S904.

In step S904, it is determined whether or not the next original document exits. When it is determined that the next original document exists, the process proceeds to step S901 to repeat the above-described processing. Then, when it is determined as a result of determination in step S904 that the scanning of the entire original document has been completed, the process proceeds to step S905. In step S905, the total number of scanned pages, the image number of composite image data stored in the non-volatile storage device 213, and the image number of unstored composite image data, are stored in the RAM 217, and the process ends. By execution of this processing, composite image data after composition can be stored until there is no available area in the non-volatile storage device 213. Note that the image number indicates, e.g. when 10 pages of original document is read, the order (number of pages) of reading of the original document. Accordingly, it can be determined by reference to the image number whether the image data to be print-outputted is stored as composite image data or as a non-composite image data.

Note that when plural pages of the original document are read and image data is stored, there is a probability that the available area in the non-volatile storage device 213 is reduced and composite image data cannot be stored in the middle of storing process. In such case, storage of composite image data cannot be performed, and in one job, image data of the original document composite image of which is stored, and image data of the original document composite image data of which is not stored, are mixed. In this case, the above-described image number of composite image data stored in the non-volatile storage device 213 and the image number of image stored as non-composite image data, stored in the RAM 21, are referred to, and the image, composite image data of which is stored or not stored, can be specified. With this processing, it can be determined whether or not the print processing is to be performed in accordance with the flowchart of FIG. 6 or the flowchart of FIG. 8.

Note that the processing of available area determination in step S902 is performed by determining whether or not an available area having the capacity of storing compressed data of at least one composite image data exists in the non-volatile storage device 213.

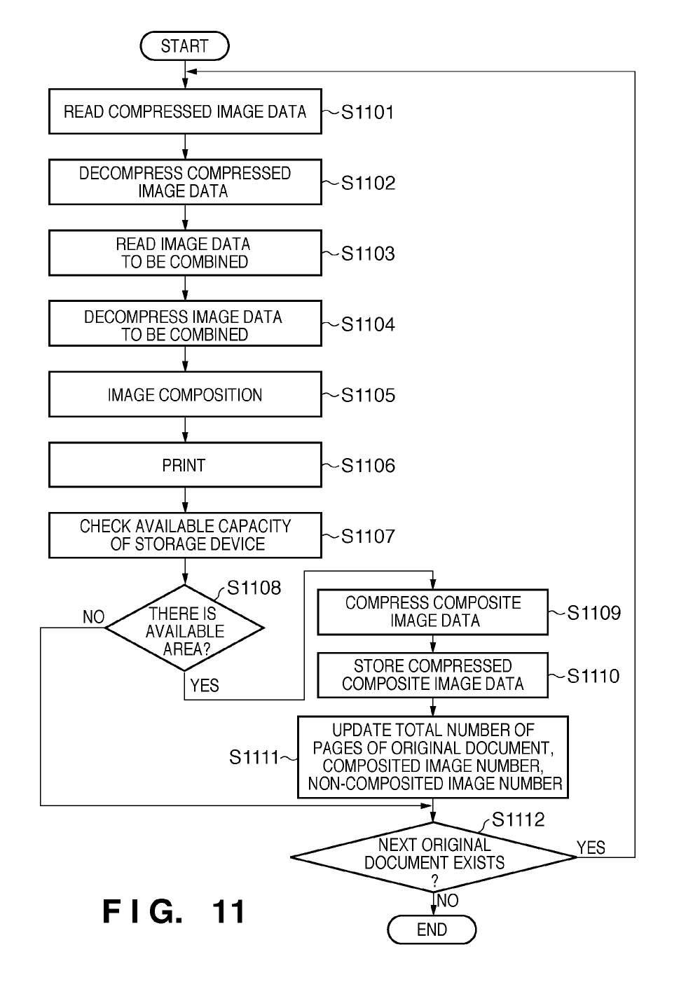

FIG. 10 is a flowchart describing the print processing (image forming processing) when non-composite compressed image data and compressed composite image after composition are mixed as one job in the non-volatile storage device 213. This processing is performed by execution of a program loaded to the RAM 217 with the CPU 215.

First, in step S1001, the previously-set number of print copies is obtained. Next, in step S1002, the total number of pages of the original document stored in the RAM 217 in step S901 in FIG. 9 is obtained. Next, in step S1003, image data of the first page of the original document is obtained. Then in step S1004, it is determined whether or not compressed composite image data of the original document is stored in the non-volatile storage device 213. The determination is made based on the image number stored in step S905 in FIG. 9 or step S1111 in FIG. 11 to be described later. When compressed composite image data is stored in the non-volatile storage device 213, the process proceeds to step S1005, in which the composite image data is decompressed and print-outputted in accordance with the processing for one page of the original document in the flowchart of FIG. 8. When compressed composite image data is not stored in the non-volatile storage device 213, the process proceeds to step S1006, in which the image data is read, decompressed, combined with image data to be combined, and print-outputted in accordance with the processing for one page of original document in the flowchart of FIG. 6. Thus, when step S1005 or step S1006 has been performed, the process proceeds to step S1007, in which it is determined whether or not printing for the total number of pages of the original document obtained in step S1001 has been completed. When it is determined that the printing for the total number of pages has not been completed, the process proceeds to step S1003 to repeat the above-described processing. Then, when the printing for the total number of pages has been completed, the process proceeds to step S1008, in which it is determined whether or not printing for the designated number of copies has been completed. When it is determined that the printing for the designated number of copies has not been completed, the process returns to step S1002 to perform the above-described processing. Thus, when the printing for the designated number of copies has been completed, the print processing ends.

With this processing, when composite image data after composition exists in the non-volatile storage device 213 in one print job, or even when composite image data after composition does not exist, print processing can be performed.

As described above, the execution speed of a print job can be improved by previously storing composite image data in the non-volatile storage device 213. Further, even when a status where the composite image data cannot be stored in the non-volatile storage device 213 occurs, as it is determined whether or not composite image data is to be stored into the non-volatile storage device 213, by page (original), interruption of execution of a print job can be prevented.

FIG. 11 is a flowchart describing processing in a case where an available area of the non-volatile storage device 213 is increased during a job due to completion of another job. This processing is performed by execution of a program loaded into the RAM 217 with the CPU 215. Note that steps S1101 to S1106 are the same as steps S601 to S606 in FIG. 6, therefore, the explanations of these steps will be omitted.

In step S1107, upon completion of printing of composite image data subjected to composition processing upon printing, it is determined whether or not an available area exists in the non-volatile storage device 213.

When it is determined in step S1108 that there is no available area, the process proceeds to step S1112, in which it is determined whether or not the next image data of the original document exists. When the next image data exists, the process proceeds to step S1101 to perform the above-described processing. Then in step S1112, when the next image data does not exist, the process ends.

On the other hand, when it is determined in step S1108 that an available area exists in the non-volatile storage device 213, the process proceeds to step S1109, in which the image data (composite image data) print-outputted in step S1106 is compressed with the CODEC 212. Next, in step S1110, the compressed composite image data is stored into the non-volatile storage device 213. Next, in step S1111, the image number of the composite image data stored in the RAM 217 in step S905 and the image number of the image data before composition are updated. Next, in step S1112, it is determined whether or not the next original document image exists. When it is determined that the next original document image exists, the processing from step S1101 is repeated. When it is determined that the next original document image does not exist, the processing of the flowchart ends.

Generally, when print processing has been completed, image data stored in the RAM 217 is deleted. However, by execution of the processing in FIG. 11, image data, which has been stored as image data before composition due to the shortage of available area in the non-volatile storage device 213, can be stored as composite image data after composition. With this processing, when printing is performed for plural copies, the processing speed upon printing of the next copy can be increased.

Note that in the above-described embodiment, upon storage in the non-volatile storage device 213, image data is compressed, however, the present invention is not limited to this arrangement. When the memory capacity is sufficient, the image data may be stored without being compressed.

Further, the determination of available area changes in accordance with operation status of the MFP 100. For example, it is conceivable that when print data is received via a network from a PC or the like or a facsimile function is performed, the amount of data stored into the non-volatile storage device 213 is large. Accordingly, in this operation status, the capacity of the available area and a predetermined amount corresponding to the status are compared with each other, and when the capacity is equal to or smaller than the predetermined amount, it is determined that there is no available area.

According to the present embodiment, when a job requiring image composition is started, it is determined whether or not composite image data is to be stored in accordance with an available area of a storage device for storage of image data, thereby the job is efficiently executed.

### Other Embodiments

Aspects of the present invention can also be realized by a computer of a system or apparatus (or devices such as a CPU or MPU) that reads out and executes a program recorded on a memory device to perform the functions of the above-described embodiment(s), and by a method, the steps of which are performed by a computer of a system or apparatus by, for example, reading out and executing a program recorded on a memory device to perform the functions of the above-described embodiment(s). For this purpose, the program is provided to the computer for example via a network or from a recording medium of various types serving as the memory device (e.g., computer-readable medium).

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2010-110596, filed May 12, 2010 which is hereby incorporated by reference herein in its entirety.

What is claimed is:

1. An image forming apparatus, comprising:
an input unit to input image data;
a composite image data generation unit to generate composite image data by combining first image data and second image data;
a determination unit to determine whether or not there is an available area to store the composite image data, in addition to the image data inputted by the input unit, in a storage unit to store image data;
a control unit to perform control to, when the determination unit determines that there is an available area, store the composite image data combined by the composite image data generation unit in addition to the image data inputted by the input unit into the storage unit, while when the determination unit determines that there is no available area, store the image data inputted by the input unit into the storage unit; and
an image forming processing unit to, when the composite image data is stored in the storage unit upon image formation, form an image in accordance with the composite image data, while when the composite image data is not stored in the storage unit, form an image in accordance with the composite image data generated by the composite image data generation unit based on the image data read from the storage unit.

2. The image forming apparatus according to claim 1, further comprising a coding/decoding unit to compress and decompress image data,
wherein the storage unit holds image data compressed by the coding/decoding unit.

3. The image forming apparatus according to claim 1, further comprising: a unit to, upon formation of the image by the image forming processing unit in accordance with the composite image data generated by the composite image data generation unit based on the image data read from the storage unit, determine whether or not there is an available area to store the composite image data in the storage unit, and when it is determined that there is an available area to store the composite image data, store the composite image data into the storage unit.

4. The image forming apparatus according to claim 1, further comprising: a memory to store image data, composite image data of which is stored in the storage unit, and information to specify image data, composite image data of which is not stored,
wherein the image forming processing unit discriminates the image data of which the composite image data is stored in the storage unit from the image data of which the composite image data is not stored in the storage unit, based on the information stored in the memory.

5. A method of controlling an image forming apparatus, comprising:
an input step of inputting image data;
a composite image data generation step of generating composite image data by combining first image data and second image data;
a determination step of determining whether or not there is an available area to store the composite image data in addition to the image data inputted in the input step in a storage unit to store image data;
a control step of performing control to, when it is determined in the determination step that there is an available area, store the composite image data combined in the composite image data generation step in addition to the image data inputted in the input step into the storage unit, while when it is determined in the determination step that there is no available area, store the image data inputted in the input step into the storage unit; and
an image forming processing step of, when the composite image data is stored in the storage unit upon image formation, forming an image in accordance with the composite image data, while when the composite image data is not stored in the storage unit, forming an image in accordance with the composite image data generated in the composite image data generation step based on the image read from said storage unit.

6. The method according to claim 5, further comprising: a coding/decoding step of compressing and decompressing image data,
wherein the storage unit holds image data compressed in the coding/decoding step.

7. The method according to claim 5, further comprising: a step of, upon formation of the image in the image forming processing step in accordance with the composite image data generated in the composite image data generation step based on the image data read from the storage unit, determining whether or not there is an available area to store the composite image data in the storage unit, and when it is determined that there is an available area to store the composite image data, storing the composite image data into the storage unit.

8. The method according to claim 5, further comprising: a memory to store image data, composite image data of which is stored in the storage unit, and information to specify image data, composite image data of which is not stored,
wherein in the image forming processing step, the image data of which composite image data is stored in the storage unit is discriminated from the image data of which composite image data is not stored in the storage unit, based on the information stored in the memory.

9. A non-transitory computer readable storage medium storing a program for causing a computer to work as an image forming apparatus comprising:
an input unit to input image data;
a composite image data generation unit to generate composite image data by combining first image data and second image data;
a determination unit to determine whether or not there is an available area to store the composite image data, in addition to the image data inputted by the input unit, in a storage unit to store image data;
a control unit to perform control to when the determination unit determines that there is an available area, store the composite image data combined by the composite image data generation unit in addition to the image data inputted by the input unit into the storage unit, while when the determination unit determines that there is no available area, store the image data inputted by the input unit into the storage unit; and
an image forming processing unit to, when the composite image data is stored in the storage unit upon image formation, form an image in accordance with the composite image data, while when the composite image data is not stored in the storage unit, form an image in accordance with the composite image data generated by the composite image data generation unit based on the image data read from the storage unit.
